(19) United States
(12) Patent Application Publication
(10) Pub. No.: US 2018/0021980 A1
(43) Pub. Date: Jan. 25, 2018

(54) Composition Comprising Calcium Magnesium Compound(s) as Compacts

(71) Applicant: S. A. Lhoist Recherche et Developpement, Ottignies-Louvain-al-Neuve (BE)

(72) Inventors: Guillaume Criniere, Braine l'Alleud (BE); Thierry Chopin, Bruxelles (BE)

(21) Appl. No.: 15/541,762

(22) PCT Filed: Jan. 8, 2016
(86) PCT No.: PCT/EP2016/050287

§ 371 Date: Jul. 6, 2017

(30) Foreign Application Priority Data
Jan. 9, 2015 (EP) 15150706.8

(51) Int. Cl. B28B 3/06; C02F 1/68; C09K 17/06; C21C 7/076; C22B 1/20

(52) U.S. Cl. CPC B28B 3/06; C21C 7/076; C22B 1/20; C09K 17/06; C02F 1/68; C21C 2007/0062

(57) ABSTRACT

Composition comprising at least one calcium-magnesium compound and a second compound chosen in the group consisting of B₂O₃, NaO₃, calcium aluminate, calcium silicate, calcium ferrite such as Ca₂Fe₂O₅ or CaFe₂O₄, Al, Mg, Fe, Mn, Mo, Zn, Cu, Si, CaF₂, C, CaC₂, CaSi, CaMg, CaFe, FeMn, FeSi, FeSiMn, FeMo; TiO₂, an oxide or a hydroxide of molybdenum, copper, zinc, and their mixture, in the form of compacts formed with compacted and shaped particles of calcium-magnesium compounds, having a Shatter Test Index of less than 20% and the manufacturing process thereof.

The present invention relates to a composition comprising at least one calcium-magnesium compound fitting the formula aCaCO₃.bMgCO₃.xCaO.yMgO.zCa(OH)₂.tMg(OH)₂.ul, wherein I is impurities; a, b, z, t and u each being mass fractions ≧0 and ≦50%, x and y each being mass fractions ≧0 and ≦100%, with x+y≧50% by weight, based on the total weight of said at least one calcium-magnesium compound.

Calcium-magnesium compounds are used in many industries, such as for example steel-making, treatment of gases, treatment of waters and sludges, agriculture, building industry, civil engineering, . . . They may be used either as pebbles or lumps, or as fines (a size of typically less than 7 mm). In certain industries, the pebble shape is nevertheless preferred. For example this is the case in steel-making during the addition of calcium-magnesium compounds in oxygen converters or else electric arc furnaces.

In order to facilitate the transportation, handling and use of such compounds, it would be more convenient to resort to compacts.

For several years, many areas have sought to transform compounds originally in powdery form into compacts (such as briquettes or tablets) to facilitate and secure their transportation, handling and use.

However, the compaction, particularly the compaction into tablets, of certain compounds in powder form at sufficient rates to allow an industrial operation and with sufficient quality and mechanical strength for the final application is made particularly difficult due to the chemical composition or physical characteristics of these powders. Indeed, some powders can have a very strong ability to seizing which can make difficult their extraction from the die after compaction into tablets.

By seizing, within the meaning of the present invention, is meant the resistance generated when extracting the tablets from the compaction device, which can be defined as the force to be applied on the tablet in order to extract it from the die.

In the case of calcium-magnesium compounds, such as lime or dolime, the compaction into tablets is made difficult due to the chemical nature of these compounds. Indeed, the presence of hydrogen bond at their surface increases the level of adhesion between the powder and the walls in the die of the compaction device, making it difficult to extract the resulting tablet from the compaction device.

By consequence, there is still a need for producing industrial compacts, meaning with good mechanical strength, homogeneous quality and at sufficient rates to allow a productivity high enough to be compatible with an industrial exploitation, of compounds in powder form, in particular of calcium-magnesium compounds, which tend to generate seizing.

Lime producers always maintain a material balance between pebble calcium-magnesium compounds and the fines generated before and during calcination as well as during subsequent handlings and operations. Nevertheless in certain cases, an excess of fines is produced. These fines may then be agglomerated together in the form of briquettes or the like, which not only give the possibility of removing the excessive fines but also of artificially increasing the production of pebble calcium-magnesium compounds by adding these briquettes or the like.

These briquettes or the like generally have a lower mechanical strength than that of pebble calcium-magnesium compounds. They often have also resistance to ageing during their storage or their handling which is much lower than that of pebble calcium-magnesium compounds. Generally, it is the presence of macrodefects which is at the origin of these not so good properties but also the absence of strong chemical bonds at the interface between the grains. This explains that in practice, the briquetting of the fines of calcium-magnesium compounds is not very used today industrially. Considering the low quality of the compacts formed by this type of method, it is estimated that briquetting provides a yield of less than 50% as there are so many unusable compacts at the output of this type of method which requires a recycling step.

In the sense of the present invention, by the terms of macrodefects, are meant any type of clefts, cracks, cleaving planes and the like, observable with the naked eye, under an optical microscope or else with a scanning electron microscope (SEM).

Over the years, several additives were used for increasing the strength and the durability of the briquettes or the like of calcium-magnesium compounds such as for example calcium stearate or paper fibers, but without leading to sufficient improvements. Moreover, in many cases, the use of additives currently used for other shaped industrial products is limited, as this is notably the case for the manufacturing of briquettes of calcium-magnesium compounds either because the calcium-magnesium compounds violently react with water, or because a potential negative effect of these additives on the final use of the briquettes of calcium-magnesium compounds.

U.S. Pat. No. 7,105,114 claims a briquetting method for (dolomitic) slaked lime fines using from 0.5 to 5% by weight of binders containing pseudo-plastic carbon chains which significantly improve the mechanical properties of the briquettes and which do not have the inconveniences mentioned earlier. The method nevertheless only leads to obtaining briquettes for which half of them are broken after a fall between 0.9 and 1.8 m (a fall between 3 and 6 feet), which represents completely insufficient mechanical strength.

Briquettes or the like based on calcium-magnesium compounds may also be consolidated by performing a heat treatment at a very high temperature which leads to the sintering of said briquettes or the like. For example in the case of baked dolomite briquettes, it is known that a heat treatment from one to a few hours at a temperature above 1200° C., and even ideally above 1300° C., leads to an increase in the mechanical properties of said briquettes. Such a heat treatment at very high temperature nevertheless leads to a time-dependent change in the textural characteristics of the aforesaid briquettes, notably it leads to a strong reduction both of the specific surface area and of the pore volume. This is also accompanied by a strong reduction in reactivity to water as described in the EN 459-2:2010 E standard, which has many problems for certain applications.

Therefore, there is a real need for developing an industrial compact product containing a calcium-magnesium compound which would be distinguished from the products as briquettes as known today by a very clear improvement in resistance to falling, as well as preferably by much better resistance to ageing in a humid atmosphere, while preserving the intrinsic properties (structural characteristics) of the calcium-magnesium compound before shaping, in particular its specific surface area and/or its pore volume.

The object of the invention is to overcome the drawbacks of the state of the art by providing a composition as mentioned in the beginning comprising particles of at least one calcium-magnesium compound fitting the formula CaCO₃.bMgCO₃.xCaO.yMgO.zCa(OH)₂.tMg(OH)₂.ul, wherein I represents impurities, a, b, z, t and u each being mass fractions ≧0 and ≦50%, x and y each being mass fractions ≧0 and ≦100%, with x+y≧50%, which is distinguished from products known to this day by a particularly high resistance to falling as well as a good resistance to ageing in a humid atmosphere, while having advantageous textural characteristics, in particular a high specific surface area and/or pore volume.

This compact product is preferably a compact product based on calcium and/or magnesium oxide, for example comprising calcium, magnesium or dolomitic quick lime or dolime (calcined dolomite). In this product, a, b, z, t and u may assume any value between 0 and 50%.

The composition may stem from a natural product, more or less calcined, more or less hydrated or not, but which will always comprise at least 50% by weight of quick products, i.e. based on calcium and/or magnesium oxide. The composition may also stem from a mixture of one or several calcium or magnesium compounds. The composition may comprise more than one calcium-magnesium compound as described above or other added mineral or organic products.

The CaCO₃, MgCO₃, CaO, MgO, Ca(OH)₂ and Mg(OH)₂ contents in calcium-magnesium compounds may easily be determined with conventional methods. For example, they may be determined by X fluorescence analysis, the procedure of which is described in the EN 15309 standard, coupled with a measurement of the loss on ignition and a measurement of the CO₂ volume according to the EN 459-2:2010 E standard.

The contents of calcium and magnesium in the form of oxides in the composition may also, in the simplest cases, be determined with the same method. In more complicated cases, such as for example compositions containing diverse mineral or organic additives, one skilled in the art will be able to adapt the battery of characterization techniques to be applied for determining these contents of calcium and magnesium in the form of oxides. As an example and in a non-exhaustive way, it is possible to resort to thermogravimetric analysis (TGA) and/or thermodifferential analysis (TDA), optionally performed under an inert atmosphere, or else further to X-ray diffraction analysis (XRD) associated with a semi-quantitative analysis of the Rietvelt type.

In order to solve this problem, a composition as indicated in the beginning, is provided according to the invention, characterized in that
said at least one calcium-magnesium compound is in the form of particles,
said composition has a cumulative calcium and magnesium content in the form of oxides, greater than or equal to 20% by weight based on the total weight of the composition,
said composition further comprises at least one second compound chosen in the group consisting of B₂O₃, NaO₃, calcium aluminate, calcium silicate, calcium ferrite such as Ca₂Fe₂O₅ or CaFe₂O₄, metal Al, metal Mg, metal Fe, metal Mn, metal Mo, metal Zn, metal Cu, elemental Si, CaF₂, C, CaC₂, alloys such as CaSi, CaMg, CaFe, FeMn, FeSi, FeSiMn, FeMo; TiO₂, an oxide based on molybdenum, an oxide based on copper, an oxide based on zinc, a hydroxide based on molybdenum, a hydroxide based on copper, a hydroxide based on zinc and their mixture,
said composition is in the form of compacts, each compact being formed with compacted and shaped particles of calcium-magnesium compounds, said compacts having a Shatter Test Index of less than 20%.

By compact, is meant fines or mixtures of fines (with a size typically below 7 mm) which are compacted or compressed in the form of tablets.

By tablet, in the sense of the present invention is meant objects shaped with a technology for industrially compacting or compressing fines because of the combined action of two punches (one in the high position, the other in the low position) on said fines placed in a cavity. The term of tablet therefore groups together the whole of the shaped objects belonging to the family of tablets, of pastilles or else further of compressed tablets, and generally objects with diverse three dimensional global shapes such as for example a substantially cylindrical, octagonal, cubic or rectangular shapes with a small asymmetry between the lower (bottom) part and the upper (top) part of said shaped objects. Said technology generally uses rotary presses or hydraulic presses.

Such type of industrial compaction method offers a productivity greater than or equal to 0.1 tph (tons per hour), preferably greater than or equal to 0.5 tph, advantageously greater than or equal to 1 tph per compaction device (press). The industrial compacts made in such process, as for example using a hydraulic press or a rotary press, such as the Titan rotary press from Eurotab, present a surface differential between their lower part and their upper part. By consequence, the industrial compact product from the present invention in the form of tablets will present an asymmetrical shape, allowing amongst other to reach a high level of productivity making it possible to reach industrial application but also industrial acceptation of the compacts according to the present invention. Indeed, the asymmetrical shape yields also to a decrease of defects in the final compacts.

Particularly, in the case of a compact presenting a global cylindrical three dimensional shape, this asymmetry will lead to a compact which could be seen as a truncated cone, if we emphasize the phenomena.

Advantageously, the difference between the surface of the upper part (surface of the top portion) and the one of the lower part (surface of the bottom portion) of the tablet is greater than or equal to 0.5%, preferably greater than or equal to 1%, and lower than or equal to 10%, preferably lower than or equal to 5%, in particular lower than or equal to 3%, notably around 2%.

The difference is a relative difference calculated by reducing the (upper) surface of the top portion with the (lower) surface of the bottom portion and by dividing the result by the median section of the compact according to [(surface of the upper portion surface of the lower portion)/Median section of the compact]. The upper part (top portion) has been designated herein as being the bigger with respect to the lower part (bottom portion) of the compact. The median diameter corresponds to the diameter measured at the middle of the height of the compact. The surface of the upper part is the one facing upwards during production, when the compact is in the die in an exemplary embodiment, while the surface of the lower part is the one facing downwards. Of course, depending on the process for manufacturing the compacts, the equipment, the contrary is also possible. Similarly, when lying on a surface as on the floor or on a table, the surface of the upper part can also be facing downwards or in any direction. By the term of Shatter Test index, in the sense of the present invention, is meant the mass percentage of the fines of less than 10 mm generated after 4 two-meter falls with initially 0.5 kg of product with a size of more than 10 mm. These 4 falls are achieved by using a tube with a length of 2 m and a diameter of 40 cm with a removable bottom (receptacle). The base of the receptacle is a polypropylene plate with a thickness of 3 mm. The receptacle rests on a concrete ground.

The compact product from the present invention in the form of tablets will be distinguished relatively to the pebble products from calcination of limestone or dolomite pebbles, by considering the internal structure. By a simple naked eye observation, with an optical microscope or else with a scanning electron microscope (SEM), the constitutive particles of the compact product from the invention may easily be shown unlike the pebble products from calcination which have a homogeneous surface in which the constitutive particles are indiscernible.

Moreover the compact product from the present invention in the form of tablets will be distinguished from the products in the form of briquettes and the like known hitherto, by also considering the internal structure. The compact product from this invention is free from macroscopic defects or macrodefects, which have a negative influence on the resistance to falling, such as clefts or cracks, unlike the products in the form of briquettes and the like, known today, which contain cracks from a few hundred micrometers to a few millimeters in length and from a few micrometers to a few hundred micrometers in width which may easily be detected by simple naked eye observation, under an optical microscope or else under a scanning electron microscope (SEM).

According to the present invention, the composition appears as a compact product highly resistant to falling and to ageing in a humid atmosphere, which is particularly important for subsequent uses where fines cannot be applied. The composition according to the invention therefore allows the utilization of fine calcium-magnesium compound particles having a d₁₀₀ of less than or equal to 7 mm in applications of calcium-magnesium compounds, which were banned up to now.

Said at least one calcium-magnesium compound according to the present invention is therefore at least formed with quick lime, quick dolomitic lime, magnesium quick lime or dolime from the calcination of natural limestones or dolomites and may comprises slaked lime, slaked dolomitic lime, magnesium slaked lime.

The impurities notably comprise all those which are encountered in natural limestones and dolomites, such as clays of the silico-aluminate type, silica, impurities based on iron or manganese, . . .

The composition according to the invention may therefore also comprise calcium or magnesium carbonates such as unfired materials from the burning of natural limestones or dolomites or else further products from the recarbonation of calcium-magnesium compounds. Finally it may also comprise calcium or magnesium hydroxides from the hydration (slaking) of calcium-magnesium compounds.

In an alternative of the composition according to the invention, the calcium-magnesium compounds completely or partly stems from the recycling of co-products, notably steel industry slags from converters. Such slags typically have a mass content from 40 to 70% of CaO and from 3 to 15% of MgO.

In a preferred embodiment according to the present invention, said second compound chosen in the group consisting of B₂O₃, NaO₃, calcium aluminate, calcium silicate, calcium ferrite such as Ca₂Fe₂O₅ or CaFe₂O₄, metal Al, metal Mg, metal Fe, metal Mn, metal Mo, metal Zn, metal Cu, elemental Si, CaF₂, C, CaC₂, alloys such as CaSi, CaMg, CaFe, FeMn, FeSi, FeSiMn, FeMo; TiO₂, an oxide based on molybdenum, an oxide based on copper, an oxide based on zinc a hydroxide based on molybdenum, a hydroxide based on copper, a hydroxide based on zinc and their mixture is comprised into the composition at a content equal or greater to 1 weight % based on the total weight of the composition.

In a particular embodiment of the composition according to the present invention, said second compound is chosen in the group consisting of B₂O₃, NaO₃, metal Al, metal Mg, metal Fe, metal Mn, metal Mo, metal Zn, metal Cu, elemental Si, CaC₂, alloys such as CaSi, CaMg, CaFe, FeMn, FeSi, FeSiMn, FeMo; TiO₂, an oxide based on molybdenum, an oxide based on copper, an oxide based on zinc, a hydroxide based on molybdenum, a hydroxide based on copper, a hydroxide based on zinc and their mixture and is comprised into the composition at a content equal to or lower than 20 weight %, preferably equal to or lower than 10 weight %, in particular equal to or lower than 5 weight % based on the total weight of the composition.

In another particular embodiment of the composition according to the present invention, said second compound is chosen in the group consisting of CaF₂, calcium ferrites like for instance Ca₂Fe₂O₅ or CaFe₂O₄ and their mixture and is comprised into the composition at a content equal to or lower than 40 weight %, preferably equal to or lower than 30 weight %, in particular equal to or lower than 20 weight % based on the total weight of the composition.

In a further other particular embodiment of the composition according to the present invention, said second compound is chosen in the group consisting of calcium aluminate, calcium silicate, carbon and their mixture and is comprised into the composition at a content equal to or lower than 60 weight %, preferably equal to or lower than 50 weight %, in particular equal to or lower than 40 weight % based on the total weight of the composition.

In an advantageous alternative according to the present invention, said at least one calcium-magnesium compound has mass fractions such that x+y≧60%, preferably ≧75%, preferentially ≧80%, particularly ≧85%, and even more preferentially ≧90%, more particularly ≧93%, or even ≧95% by weight, based on the total weight of said at least one calcium-magnesium compound.

In this advantageous alternative, said at least one calcium-magnesium compound is in majority a compound based on calcium and/or magnesium oxide and therefore is an active calcium-magnesium compound.

In a particular advantageous embodiment, said at least one calcium-magnesium compound has mass fractions such that x≧60%, preferably ≧75%, preferentially ≧80%, particularly ≧85%, and even more preferentially ≧90%, more particularly ≧93%, or even ≧95% by weight, based on the total weight of said at least one calcium-magnesium compound.

In this advantageous embodiment, said at least one calcium-magnesium compound is in majority a compound based on calcium oxide and therefore is an active calcium compound.

In another advantageous embodiment, the composition according to the invention has a cumulative content of calcium and magnesium in the form of oxides, greater than or equal to 40% by weight, advantageously ≧60% by weight, preferably ≧80% by weight, particularly ≧85%, in particular ≧90% by weight, preferentially ≧93% by weight, or even equal to 95% by weight based on the total composition.

In a particular advantageous embodiment, the composition according to the invention has a content of calcium in the form of oxides greater than or equal to 40% by weight, advantageously ≧60% by weight, preferably ≧80% by weight, particularly ≧85%, in particular ≧90% by weight, preferentially ≧93% by weight, or even equal to 95% by weight based on the total composition.

Advantageously, said compacts have a Shatter Test Index of less than 15%, preferably less than 10%, in particular less than 8%. More particularly, according to the present invention, said compacts have a Shatter Test Index of less than 6%. More advantageously, said compacts have a Shatter Test Index of less than 4%. And even more advantageously, said compacts have a Shatter Test Index of less than 3%.

Advantageously, the composition according to the present invention has a specific surface area measured by manometry with adsorption of nitrogen after degassing in vacuo at 190° C. for at least 2 hours and calculated according to the multipoint BET method as described in the ISO 9277:2010E standard, of more than or equal to 0.4 m²/g, preferably greater than or equal to 0.6 m²/g, more preferentially greater than or equal to 0.8 m²/g and even more preferentially greater than or equal to 1.0 m²/g and in particular greater than or equal to 1.2 m²/g, which is much greater than that of sintered products which generally have a specific surface area of less than or equal to 0.1 m²/g.

In this way, the composition has a relatively high specific surface area as compared with the sintered briquettes above notably by preserving the intrinsic properties/structural characteristics of the calcium-magnesium compound before its shaping.

Said composition is also characterized in that its total pore volume (determined by porosimetry with intrusion of mercury according to Part 1 of the ISO 15901-1:2005E standard which consists of dividing the difference between the skeleton density measured at 30000 psia, (207 Mpa), and the apparent density, measured at 0.51 psia (3.5 kPa), by the skeleton density) is greater than or equal to 20%, preferably greater than or equal to 25% and even more preferentially greater than or equal to 30%, which is much greater than that of sintered products which generally have a total pore volume of less than or equal to 10%.

Advantageously, the composition according to the invention has a relatively high total pore volume as compared with the sintered briquettes above, notably by preserving the intrinsic properties/structural characteristics of the calcium-magnesium compound before shaping.

Advantageously, said composition has a homogeneous density distribution within the compact. The proposed compaction method using a uniaxial press actually allows formation of compacts where the density is substantially the same along the longitudinal direction (i.e. along the longitudinal displacement axis of the punches) and along the transverse direction (i.e. perpendicularly to the longitudinal displacement axis of the punches).

A low density gradient may exist along the longitudinal direction notably when only one of the punches is in motion relatively to the other one, the highest density being found on the side of the active punch, and the lowest density being found on the opposite side where the punch is inactive.

According to the present invention, said compacts also have a Shatter Test Index of less than 20%, preferably less than 10% after an Accelerated Ageing Test of level 1 at 30° C. under 75% of relative humidity (i.e. 22.8 g/m³ of absolute humidity) for 2 hours.

By Accelerated Ageing Test, in the sense of the present invention, is meant ageing for 2 hours made in a weather chamber starting with 0.5 kg of product with a size greater than or equal to 10 mm placed as a monolayer on a grid itself placed above a receptacle, so that the contact between the product and the humid atmosphere is optimum, i.e. each of said constitutive compacts of the product is spaced apart from the other compacts by at least 1 cm. The increase in the mass during ageing quantifies the water absorption and therefore the hydration of the composition.

The Shatter Test Index measured after ageing is obtained starting with the totality of the product, i.e. even if the Accelerated Ageing Test has generated by itself fines, they are properly counted in the final result. The Accelerated Ageing Test may be carried out under different temperature and relative humidity conditions—and therefore of absolute humidity—so as to modulate its intensity. Four intensity levels ranging from 1 (the less severe test) to 4 (the most severe test) were used:
Level 1: 30° C. and 75% of relative humidity leading to an absolute humidity of 22.8 g/m³;
Level 2: 40° C. and 50% of relative humidity leading to an absolute humidity of 25.6 g/m³;
Level 3: 40° C. and 60% of relative humidity leading to an absolute humidity of 30.7 g/m³;
Level 4: 40° C. and 70% of relative humidity leading to an absolute humidity of 35.8 g/m³.

Advantageously, said compacts have a Shatter Test Index of less than 20%, preferably less than 10%, after an Accelerated Ageing Test of Level 2 at 40° C. under 50% of relative humidity (i.e. 25.6 g/m³ of absolute humidity) for 2 hours.

More advantageously, said compacts have a Shatter Test Index of less than 20%, preferably less than 10%, after an Accelerated Ageing Test of Level 3 at 40° C. under 60% of relative humidity (i.e. 30.7 g/m³ of absolute humidity) for 2 hours.

Even more advantageously, said compacts have a Shatter Test Index of less than 20%, in particular less than 10%, more particularly, less than 5% and even most particularly less than 3%, after an accelerated ageing test of Level 4 at 40° C. under 70% of relative humidity (i.e. 35.8 g/m³ of absolute humidity) for 2 hours.

According to the present invention, the composition may further comprise at least one third compound chosen in the group consisting of an organic additive chosen in the group consisting of a binder, a lubricant and their mixture , an oxide chosen in the group consisting of an oxide based on aluminum, an oxide based on silicon, an oxide based on iron, an oxide based on manganese, and their mixture, a hydroxide chosen in the group consisting of a hydroxide based on aluminum, a hydroxide based on silicon, a hydroxide based on iron, a hydroxide based on manganese and their mixture, preferably at a content equal to or greater than 1 weight % and equal to or lower than 40 weight %, based on the total weight of the composition.

The organic carbon percentage present in the composition according to the invention may be calculated by a difference between the total carbon percentage and the percentage of carbon of mineral origin. Total carbon is for example measured by C/S analysis according to the ASTM C25 (1999) standard and the carbon of mineral origin is determined for example by dosing the CO₂ volume according to the EN 459-2:2010 E standard.

The composition according to the invention may, as it can be seen, further comprise one or more oxides based on aluminum, in particular at a content comprised in the range from 1 to 40% and preferably from 5 to 30% by weight based on the total weight of the composition, expressed as Al₂O₃ equivalent, such as for example corundum, boehmite, or further amorphous alumina.

The composition according to the invention may also further comprise one or more hydroxides based on aluminum, in particular at a content comprised in the range from 1 to 40% and preferably from 5 to 30% by weight based on the total weight of the composition expressed as Al₂O₃ equivalent, such as for example boehmite, gibbsite or further diaspore.

The composition may also comprise one or several oxides based on silicon, in particular at a content comprised in the range from 1 to 30% and preferably from 5 to 20% by weight, based on the total weight of the composition, expressed as SiO₂ equivalent, such as for example pyrogenated silica or further precipitation silica.

In an advantageous embodiment, as it can be seen, the composition may also comprise one or several hydroxides based on silicon, in particular at a content comprised in the range from 1 to 30%, and preferably from 5 to 20% by weight based on the total weight of the composition, expressed as SiO₂ equivalent.

In another embodiment, the composition according to the invention further comprises one or several oxides based on iron, in particular at a content comprised in the range from 1 to 30% and preferably from 5 to 20% by weight based on the total weight of the composition, expressed as Fe₂O₃ equivalent, such as for example hematite, magnetite, or further wustite.

In another embodiment, the composition according to the invention further comprises one or several hydroxides based on iron, in particular at a content comprised in the range from 1 to 30% and preferably from 5 to 20% by weight based on a total weight of the composition, expressed as Fe₂O₃ equivalent, such as for example goethite or further limonite.

In still another embodiment, the composition according to the present invention comprises one or several oxides based on manganese, in particular at a content comprised in the range from 1 to 10% and preferably from 1 to 5% by weight based on the total weight of the composition, expressed as MnO equivalent, such as for example pyrolusite or else further manganese monoxide MnO.

In still another embodiment, the composition according to the present invention comprises one or several hydroxides based on manganese, in particular at a content comprised in the range from 1 to 10% and preferably from 1 to 5% by weight based on the total weight of the composition expressed as MnO equivalent.

In a particular embodiment of the composition according to the invention, said particles have a size of less than or equal to 7 mm, observable by optical microscopy or scanning electron microscopy and before compaction have a particle size d₁₀₀ of less than or equal to 7 mm, in particular less than or equal to 5 mm, as for example measured by sieving.

According to the present invention, the composition therefore appears as compacts which are initially obtained starting with fine composites of particles of calcium-magnesium compounds having a d₁₀₀ of less than or equal to 7 mm and which are finally highly resistant to falling and to ageing in a humid atmosphere, which is particularly of importance for subsequent uses where the fines cannot be applied. The composition according to the invention therefore allows inter alia, as noted above, the utilization of fine particles of calcium-magnesium compounds having a d₁₀₀ of less than or equal to 7 mm, in applications of calcium-magnesium compounds which were banned up to now.

The notation dₓ represents a diameter expressed in mm, relatively to which X % by mass of the measured particles are smaller or equal.

In a particular advantageous embodiment of the invention, said particles of calcium-magnesium compounds before compaction have a d₉₀ of less than or equal to 3 mm, in particular less than or equal to 2 mm.

More particularly, said particles of calcium-magnesium compounds before compaction have a d₅₀ of less than or equal to 1 mm, in particular less than or equal to 500 μm, and a d₅₀ greater than or equal to 0.1 μm, in particular greater than or equal to 0.5 μm, in particular greater than or equal to 1 μm.

According to another advantageous embodiment of the present invention, said compacts are of a global regular and homogeneous shape, typical of products from methods for shaping fines via a dry route, for example selected from the group of tablets, but with a small asymmetry between the lower (bottom) part and the upper (top) part of said compacts, and have a size, such as a median diameter, comprised between 10 and 100 mm, preferably greater than or equal to 15 mm, preferably greater than or equal to 20 mm, and preferably less than or equal to 70 mm, in particular less than or equal to 50 mm.

By size of the compacts is meant that of those which cross through a sieve or screen, for example with square meshes.

More particularly, in the sense of the present invention, said compacts have an average weight per compact of at least 1 g, preferably of at least 5 g, preferentially of at least 10 g and in particular of at least 15 g.

In a preferred embodiment of the present invention, said compacts have an average weight per compact of less than or equal to 200 g, preferably less than or equal to 150 g, preferentially less than or equal to 100 g and in particular less than or equal to 50 g.

Advantageously, said compacts have an apparent density (volume mass) comprised between 1.5 g/cm³ and 3 g/cm³, advantageously between 1.5 g/cm³ and 2.8 g/cm³ and preferably between 1.7 g/cm³ and 2.6 g/cm³.

In an advantageous embodiment of the invention, said compact includes a through-orifice.

The shape of these compact products is easily distinguished from that of pebble calcium-magnesium compounds traditionally obtained after calcination of rock limestone or dolime.

The composition according to the present invention is preferably packaged in industrial container types having a volume of content of more than 1 m³ such as big bags, containers, silos and others, preferably sealed, for transportation and storage, to avoid reaction of the CaO and/or MgO with ambient humidity. In some cases, trucks, trains or boats can transport industrial compacts from one industrial container as a storage silo to another industrial container, such as another storage silo, but in any case, as quickly as possible, as for many quick calco-magnesium lime compounds.

Other embodiments of the composition according to the invention are indicated in the appended claims.

The present invention also relates to a composite material comprising several successive layers in order to form a multi-layer structure wherein at least one layer is formed with said compact product with the composition according to the invention.

Other embodiments of the composite materials according to the invention are indicated in the appended claims.

The present invention also relates to a method for making a composition in the form of a compact comprising the following successive steps:
a) providing particles of at least one calcium-magnesium compound fitting the formula aCaCO₃.bMgCO₃.xCaO.yMgO.zCa(OH)₂.tMg(OH)₂.ul, wherein I represents impurities, a, b, z, t and u each being mass fractions ≧0 and ≦50%, x and y each being mass fractions ≧0 and ≦100%, with x+y≧50% by weight based on the total weight of the calcium-magnesium compound
b) adding at least one second compound to the particles of at least one calcium-magnesium compound, chosen in the group consisting of B₂O₃, NaO₃, calcium aluminate, calcium silicate, calcium ferrite such as Ca₂Fe₂O₅ or CaFe₂O₄, metal Al, metal Mg, metal Fe, metal Mn, metal Mo, metal Zn, metal Cu, elemental Si, CaF₂,C, CaC₂, alloys such as CaSi, CaMg, CaFe, FeMn, FeSi, FeSiMn, FeMo; TiO₂ an oxide based on molybdenum, an oxide based on zinc, an oxide based on copper, a hydroxide based on molybdenum, a hydroxide based on copper, a hydroxide based on zinc, and their mixture, at a content equal to or greater than 1 weight % based on the total weight of the composition,
c) mixing said particles and the second compound until an homogeneous composition is reached,
d) providing said homogeneous composition in a confinement space between two punches having a section comprised between 1 and 40 cm², advantageously comprised between 1 and 20 cm², preferably between 1 and 10 cm², in particular between 2 and 10 cm²,
e) compacting said homogeneous composition for forming a compact product with a three-dimensional shape, by applying a compaction pressure comprising 200 MPa and 800 MPa, preferably comprised between 250 MPa and 600 MPa, more preferentially between 300 and 500 MPa, and even more preferentially between 350 and 500 MPa,
f) releasing the compaction pressure and
g) ejecting said compact product from said confinement space.

Advantageously, the method according to the present invention comprises a further step of h) packaging of the resulting compact products into containers as previously mentioned, preferably sealed.

As previously mentioned, the extraction of the resulting compact product from the confinement space is made possible and effective on an industrial scale by generating a surface differential between the lower part and the upper part of said compact product. This feature can be obtained in a preferred embodiment by using a die having an internal wall defining at least said confinement space having a section which is reducing downwards. More precisely, the lower section of the confinement space accommodating the compact is preferably lower than the upper section of the confinement space accommodating the compact.

Indeed, due to the asymmetrical shape of the compact, its surface is almost no longer in contact with the walls of the compaction device at the very beginning of the extraction step, limiting therefore the problems of seizing as well as decreasing the defects in the final compacts. This facilitates the extraction of the compact from the confinement space accommodating the compact, the latter acting by consequence only as a directional guide.

The process according to the present invention allows therefore high rate of production, compatible with an industrial exploitation.

In particular, the process according to the present invention offers a productivity greater than or equal to 0.1 tph (tons per hour), preferably greater than or equal to 0.5 tph, advantageously greater than or equal to 1 tph, and lower than or equal to 20 tph, per compacting device.

Advantageously, the process according to the present invention offers a productivity greater than or equal to 100 cpm (compacts per minutes), preferably greater than or equal to 500 cpm, in particular greater than or equal to 1000 cpm, and lower than or equal to 20,000 cpm, preferably lower than or equal to 10,000 cpm, per compacting device.

Those productivity values are expressed for a compacting equipment (press). Obviously, if several compacting equipments are used simultaneously, the productivity will increase correspondingly.

In a particular embodiment of the method according to the present invention, said second compound is chosen in the group consisting of B₂O₃, NaO₃, metal Al, metal Mg, metal Fe, metal Mn, metal Mo, metal Zn, metal Cu, elemental Si, CaC₂, alloys such as CaSi, CaMg, CaFe, FeMn, FeSi, FeSiMn, FeMo; TiO₂, an oxide based on molybdenum, an oxide based on copper, an oxide based on zinc, a hydroxide based on molybdenum, a hydroxide based on copper, a hydroxide based on zinc and their mixture and is comprised into the composition at a content equal to or lower than 20 weight %, preferably equal to or lower than 10 weight %, in particular equal to or lower than 5 weight % based on the total weight of the composition.

In another particular embodiment of the method according to the present invention, said second compound is chosen in the group consisting of CaF₂, calcium ferrites like for instance Ca₂Fe₂O₅ or CaFe₂O₄ and their mixture and is comprised into the composition at a content equal to or lower than 40 weight %, preferably equal to or lower than 30 weight %, in particular equal to or lower than 20 weight % based on the total weight of the composition.

In a further other particular embodiment of the method according to the present invention, said second compound is chosen in the group consisting of calcium aluminate, calcium silicate, carbon and their mixture and is comprised into the composition at a content equal to or lower than 60 weight %, preferably equal to or lower than 50 weight %, in particular equal to or lower than 40 weight % based on the total weight of the composition.

Advantageously, the method according to the present invention comprises a further step of adding a third compound chosen in the group consisting of an organic additive chosen in the group consisting of a binder, a lubricant and their mixture, an oxide chosen in the group consisting of an oxide based on aluminum, an oxide based on silicon, an oxide based on iron, an oxide based on manganese, and their mixture, a hydroxide chosen in the group consisting of a hydroxide based on aluminum, a hydroxide based on silicon, a hydroxide based on iron, a hydroxide based on manganese and their mixture, said third compound having a hardness greater than or equal to 5 on the Mohs scale, and a size of particles d₁₀₀ of less than or equal to 200 μm, preferably less than or equal to 150 μm and more preferentially less than or equal to 100 μm, before said step of providing said homogeneous composition in a confinement space d).

As it can then be seen, the particle composition which is provided may contain, without however this being necessary, additives either of an organic nature such as for example conventional binders or lubricants, or of a mineral nature such as for example oxides or hydroxides based on aluminum, in particular in an amount from 1 to 40% and preferably from 5 to 30% expressed as Al₂O₃ equivalent, on silicon, in particular in an amount from 1 to 30% and preferable 5 to 20% expressed as SiO₂ equivalent, on iron, in particular an amount from 1 to 30% and preferably 5 to 20% expressed as Fe₂O₃ equivalent, on manganese in particular in an amount from 1 to 10% and preferably 1 to 5% expressed as MnO equivalent, or further mineral additives with a hardness greater than or equal to 5 on Mohs scale, characterized in that their particles have a size d₁₀₀ of less than or equal to 200 μm, preferably less than or equal to 150 μm and more preferentially less than or equal to 100 μm.

Advantageously, said step for providing the particle composition is controlled and occurs in such a way that it is always the same amount of same composition which is placed in said confined space between said two punches.

In another embodiment of the method of the present invention, said confined space between said two punches is lubricated beforehand by means of a lubrication step during which a lubricant as a powder, such as for example calcium or magnesium stearate, is deposited at the surface of said confined space between said two punches, said lubricant as a powder being compacted with the particles of the composition of the particles and advantageously represents between 0.01 and 0.3% by weight, preferably between 0.02 and 0.1% by weight based on the total weight of the compact product. This embodiment therefore gives the possibility of external lubrication, i.e. lubrication of the punches and of the dies, which is more economical than internal lubrication, which consists of adding a lubricant directly within the composition to be compacted and which usually requires 0.25% to 1% by weight of lubricant. This further avoids adding complementary compounds into the composition to be compacted, thereby avoiding the risk of denaturation.

This method allows the formation of a compact based on one or several calcium-magnesium compounds having very good resistance to falling and good resistance to ageing.

By considering the internal texture, moreover, this compact from said method will be distinguished from the products known to this day such as for example the briquettes which stem from shaping methods using presses with rollers. The compact according to the invention is free from macrodefects such as clefts, cracks or cleaving planes unlike the products in the form of briquettes and the like known to this day which contain clefts from a few hundred micrometers to a few millimeters in length and from a few micrometers to a few hundred micrometers in width which may easily be detected by simple observation with the naked eye, with an optical microscope or else with a scanning electron microscope (SEM).

According to an embodiment, a rotary press is used for carrying out the compression, but generally, the compaction system may be of any type, for example, a hydraulic press may also be used. In principle, these compaction systems comprise a die describing an internal wall portion inside which may slide one or two punches, these elements forming said confinement space in which the composition is placed for compaction.

The space inside the internal wall portion of the die is closed with one punches forming a bottom wall during filling with the homogeneous powdery composition made of said at least one calcium-magnesium compound and said at least one second compound.

It is the action of the punches which exerts the compaction stress required for forming the compact. This applied compaction stress may consist of bringing the composition to a determined compaction pressure, which corresponds for the confined space between the two punches to a certain volume and therefore to a certain position of the punches, and of optionally maintaining the position of these punches for a determined time which may range up to about one hundred milliseconds, while being aware that maintaining this position for a longer duration is not detrimental, but does not have any additional benefit.

The said position of the punches defining a certain volume of the compacts defines a portion of the die called the compact portion while the remaining portion of the die is called guiding part (which latter can be above and/or under the compact portion of the die. The compact portion of the die is the portion accommodating the compact at the end of the compact production as the volume at filling time is greater than the volume at the ejection time due to the compaction.

The compact portion inside the internal wall presents an upper section and a lower section corresponding respectively in an exemplary embodiment to the surface of the upper part (surface of the top portion) of the compact and to the surface of the lower part (surface of the bottom portion) of the compact.

The difference between the upper section and the lower section of the compact portion inside the die is correspondingly greater than or equal to 0.5%, preferably greater than or equal to 1%, and lower than or equal to 10%, preferably lower than or equal to 5%, in particular lower than or equal to 3%, notably lower than or equal to 2%.

The difference is a relative difference calculated by reducing the upper section of the compact portion inside the die with the lower section of the compact portion inside the die and by dividing the result by the median section of the compact portion according to [(upper section of the compact portion lower section of the compact portion)/Median section of the compact portion]. The upper section has been designated herein as being the bigger with respect to the lower section of the compact portion. The upper section is the one facing upwards during production, when the compact is in the die in an exemplary embodiment, while the lower section is the one facing downwards. Of course, depending on the process for manufacturing the compacts, the equipment, the contrary is also possible.

In a particular embodiment, the inside wall of the die presents preferably straight internal faces and defines a space called the confinement space which has a section, at least in the compact portion reducing downwards, with the compact ejected upwards by the punches forming the bottom of the compact portion.

In another embodiment according to the present invention, it is foreseen that the compact is ejected downwards. In such a case, the inside wall of the die presents preferably straight internal faces and defines a space called the confinement space which has a section, at least in the compact portion reducing upwards, with the compact ejected downwards by the punches forming the top of the compact portion.

A rotary press with punches operates at high compaction pressures. In principle, the compaction system comprises a rotary platform having cavities forming dies in which may slide one or two punches, these elements forming a confinement space in which the composition is placed for compaction.

The geometry and the operation of a rotary press allows better transmission of the force on the product to be compacted, which generates better homogenization of the density distribution in the compact and therefore better mechanical strength and less structural defects.

The use of a rotary press for forming the compacted products based on calcium-magnesium oxides moreover gives the opportunity of better controlling the kinetics and kinematics of compaction with the possibility of pre-packing and/or pre-compaction giving the possibility of better densifying the powder and driving out the air thereby avoiding the formation of defects such as cleaving or capping.

Advantageously, in the method according to the present invention, said collective compact product is then thermally treated between 700° C. and 1200° C. for a predetermined time period comprised between 1 and 90 minutes, preferably greater than or equal to 5 minutes and less than or equal to 60 minutes, more particularly greater than or equal to 10 minutes and less than or equal to 30 minutes.

Advantageously, the thermal treatment is carried out above 800° C., advantageously above 900° C., and below 1100° C., preferably below 1000° C.

In a particular embodiment, the thermal treatment moreover includes temperature raising and lowering ramps as short as possible so that the productivity of said thermal treatment is optimum.

This method allows the formation of a compact based on one or several calcium-magnesium compounds having very good resistance to falling and very good resistance to ageing.

According to an embodiment, a horizontal oven such as for example a tunnel oven, a passage oven, a roller kiln or further a mesh belt kiln is used for carrying out the thermal treatment. Alternatively, any other type of conventional oven, but not leading to alteration of the integrity of the compacts, for example because of too large attrition, may be used.

In still another embodiment, the method according to the invention further comprises a step for surface treatment of said collected compact product, optionally after thermal treatment if it is present, at a temperature greater than or equal to 50° C., preferably greater than or equal to 100° C., preferably greater than or equal to 150° C. and less than or equal to 700° C., advantageously less than or equal to 500° C., preferably less than or equal to 400° C., in particular less than or equal to 300° C., advantageously less than or equal to 250° C., for a time period comprised between 5 and 60 minutes, preferably comprised between 10 and 30 minutes under a gas flow containing CO₂ and steam.

Advantageously, the gas flow comprises a steam concentration comprised between 5 and 25% by volume and preferably between 5 and 15%.

Preferably the gas flow comprises a CO₂ concentration in the gas comprised between 5 and 40% by volume and preferably between 10 and 25%.

More particularly, the gas flow used stems from combustion fumes, for example from a traditional lime kiln.

With this method it is possible to form a compact based on one or several calcium-magnesium compounds having very good resistance to falling and very good resistance to ageing.

According to an embodiment, a vertical counter-current reactor fed with compacts through the top and with gas through the bottom is used for carrying out said surface treatment.

Advantageously, the increase in the temperature of the compacts may be directly achieved via the injection of said gas already hot or preheated beforehand, as this would be the case for example from gas stemming from combustion fumes.

Although this is not necessary, the benefit will be well understood for economical, environmental and sustainable activity reasons for carrying out this surface treatment with combustion fumes rather than with synthetic gases containing carbon dioxide and steam.

In one alternative, the present invention relates to a method for making composite material comprising several successive layers for forming a multi-layer structure wherein at least one layer is formed with said compact product of the composition by the method according to the invention and further comprising an additional step for compacting said at least one layer of said compact product and of another compact layer.

Other embodiments of the method according to the invention are indicated in the appended claims.

The object of the invention is also a use of the composition according to the present invention or stemming from the method according to the present invention in steel industry, in particular in oxygen converters or else in electric arc furnaces, in the treatment of flue gases, in the treatment of waters, in the treatment of waste sludges and waters, in agriculture, building industry and civil engineering such as for example for stabilizing soils.

Other forms of use according to the invention are indicated in the appended claims.

Other features, details and advantages of the invention will become apparent from the description given hereafter, as non-limiting and with reference to the appended examples.

### EXAMPLE

### Example 1

A powder mixer Gericke GCM450 is used with a capacity of 10 dm³, provided with standard blade of a radius of 7 cm rotating at 350 rpm (i.e. 2.6 m/s). This mixer is used in a continuous mode to prepare a mixture comprising 85 weight % of quicklime fines 0-3 mm and 15 weight % of CaF₂ powder (fluospar CaF₂) 0-6 mm. The total flow rate of the powder is 300 kg/h and the residence time is 3.5 s. The resulting mixture is very homogeneous, meaning that the amount of CaF₂ for different samples of 10 g withdrawn in the final mixture is each time comprised between 14 and 16 weight % based on the total weight of the composition.

A rotary press Eurotab of the Titan type is used. Such rotary press comprises a die having an internal wall defining at least said confinement space having a section which is reducing downwards. The lower section of the confinement space accommodating the compact is lower than the upper section of the confinement space accommodating the compact, for facilitating the ejection of the compact from the confinement space, and offers a productivity of at least 100 cpm (compacts per minute). Starting with about thirty kilograms of slaked lime fines of 0-3 mm, 12.7 g of this mixture are successively poured into each of the dies of the tooling with a substantially cylindrical shape having a section reducing downwards for the compact portion and with a diameter of about 21 mm. Compression is carried out under a compression of 500 MPa, with a closing-in speed of the punches of 115 mm/s and a maintaining time of 100 ms.

Several kilograms of substantially cylindrical compacts each having a weight of 12.6 g and a median diameter of a mean value of 21.4 mm are obtained. The upper diameter of the upper (top) part of the compacts has a mean value of 21.51 mm and the lower diameter of the lower part (bottom) of the compacts has a mean value of 21.29 mm, leading respectively to an upper surface of the upper part with a mean value of 363 mm² and to a lower surface of the lower part with a mean value of 356 mm². By consequence, the difference between the mean upper surface and the mean lower surface of said compacts reported to the mean median section of the compact is equal to 2.06% [(mean upper surface of the upper part-lower surface of the lower part)/median section of the compact]. The height is 15.9 mm and the density is 2.20 g/cm³. These compacts are of a homogeneous quality and are free from macroscopic defects.

These compacts develop a specific BET surface area (as measured by manometry with adsorption of nitrogen after degassing in vacuo at 190° C. for at least two hours and calculated according to the multipoint BET method as described in the ISO 9277:2010E standard) of 1.8 m²/g and have a total mercury pore volume of 34% (as determined by porosimetry by introduction of mercury according to part 1 of the ISO 15901-1:2005E standard which consists of dividing the difference between the skeleton density, measured at 30000 psia, and the apparent density, measured at 0.51 psia, by the skeleton density).

A Shatter Test is performed starting with 0.5 kg of these compacts by successively performing 4 two-meter falls. The amount of fines of less than 10 mm, generated at the end of these 4 falls is weighed. A Shatter Test Index of 2.8% is obtained.

### Example 2

A powder mixer Gericke GCM450 is used with a capacity of 10 dm³, provided with standard blade of a radius of 7 cm rotating at 350 rpm (i.e. 2.6 m/s). This mixer is used in a continuous mode to prepare a mixture comprising 85 weight % of quicklime fines 0-3 mm and 15 weight % of CaF₂ powder (fluospar CaF₂) 0-6 mm. The total flow rate of the powder is 300 kg/h and the residence time is 3.5 s. The resulting mixture is very homogeneous, meaning that the amount of CaF₂ for different samples of 10 g withdrawn in the final mixture is each time comprised between 14 and 16 weight % based on the total weight of the composition.

A rotary press Eurotab of the Titan type as described in example 1 is used. Starting with about thirty kilograms of slaked lime fines of 0-3 mm, 12.7 g of this mixture are successively poured into each of the dies of tooling with a substantially cylindrical shape having a section reducing downwards for the compact portion and with a diameter of about 21 mm. Compression is carried out under a compression of 430 MPa, with a closing-in speed of the punches of 115 mm/s and a maintaining time of 100 ms.

Several kilograms of substantially cylindrical compacts each having a weight of 12.6 g and median diameter having a mean value of 21.5 mm are obtained. The height is 17.4 mm and the density is 2.1 g/cm³. These compacts are of a homogeneous quality and are free from macroscopic defects.

These compacts develop a specific BET surface area (as measured by manometry with adsorption of nitrogen after degassing in vacuo at 190° C. for at least two hours and calculated according to the multipoint BET method as described in the ISO 9277:2010E standard) of 1.6 m²/g and have a total mercury pore volume of 42% (as determined by porosimetry by introduction of mercury according to part 1 of the ISO 15901-1:2005E standard which consists of dividing the difference between the skeleton density, measured at 30000 psia, and the apparent density, measured at 0.51 psia, by the skeleton density).

A Shatter Test is performed starting with 0.5 kg of these compacts by successively performing 4 two-meter falls. The amount of fines of less than 10 mm, generated at the end of these 4 falls is weighed. A Shatter Test Index of 7.9% is obtained.

### Example 3

A powder mixer Gericke GCM450 is used with a capacity of 10 dm³, provided with standard blade of a radius of 7 cm rotating at 350 rpm (i.e. 2.6 m/s). This mixer is used in a continuous mode to prepare a mixture comprising 70 weight % of quicklime fines 0-3 mm and 30 weight % of CaF₂ powder (fluospar CaF₂) 0-6 mm. The total flow rate of the powder is 300 kg/h and the residence time is 3.5 s. The resulting mixture is very homogeneous, meaning that the amount of CaF₂ for different samples of 10 g withdrawn in the final mixture is each time comprised between 28 and 32 weight % based on the total weight of the composition.

A rotary press Eurotab of the Titan type as described in example 1 is used. Starting with about thirty kilograms of a mixture consisting of 50% of slaked lime fines of 0-3mm and of 50% of slaked dolime fines of 0-3 mm, 12.5 g of this mixture are successively poured in each of the dies of the tooling with a substantially cylindrical shape having a section reducing downwards for the compact portion and a diameter of about 21 mm. Compression is performed under a pressure of 590 MPa, with a closing-in speed of the punches of 115 mm/s and a maintaining time of 105 ms.

Several kilograms of compacts each having a weight of 12.5 g and a median diameter having a mean value of 21.4 mm are obtained. The height is 15.6 mm and the density is 2.32 g/cm³. These compacts have homogeneous quality and are free of macroscopic defects.

These compacts develop a BET specific surface area of 1.5 m²/g and have a total mercury pore volume of 35%.

A Shatter Test is conducted starting with 0.5 kg of these compacts by successively performing 4 two-meter falls. The amount of fines of less than 10 mm generated at the end of these 4 falls is weighed. A Shatter Test Index of 5.2% is obtained.

### Example 4

A powder mixer Gericke GCM450 is used with a capacity of 10 dm³, provided with standard blade of a radius of 7 cm rotating at 350 rpm (i.e. 2.6 m/s). This mixer is used in a continuous mode to prepare a mixture comprising 70 weight % of quicklime fines 0-3 mm and 30 weight % of CaF₂ powder (fluospar CaF₂) 0-6 mm.

The total flow rate of the powder is 300 kg/h and the residence time is 3.5 s. The resulting mixture is very homogeneous, meaning that the amount of CaF₂ for different samples of 10 g withdrawn in the final mixture is each time comprised between 28 and 32 weight % based on the total weight of the composition.

A rotary press Eurotab of the Titan type as described in example 1 is used. Starting with about thirty kilograms of slaked lime fines of 0-3 mm, 9.4 g of these fines are successively poured in each of the dies of the tooling with a substantially cylindrical shape having a section reducing downwards for the compact portion and a diameter of about 21 mm. Compression is performed under a pressure of 480 MPa, with a closing-in speed of the punches of 115 mm/s and a maintaining time of 100 ms.

Several kilograms of compacts are obtained, each having a weight of 13.5 g and an average dimension (median diameter) of 21.3 mm are obtained. The height is 17.85 mm and the density is 2.1 g/cm³.

These compacts develop a BET specific surface area of 1.3 m²/g and have a total mercury pore volume of 40%.

A Shatter Test is conducted starting with 0.5 kg of these compacts by successively performing 4 two-meter falls. The amount of fines of less than 10 mm generated at the end of these 4 falls is weighed. A Shatter Test Index of 8.5% is obtained.

### Example 5

A powder mixer Gericke GCM450 is used with a capacity of 10 dm³, equipped with standard blades with a radius of 7 cm, used in rotation at 350 revolutions per minute (i.e. 2.6 m/s). This mixer is used in a continuous mode in order to prepare a mixture consisting of 89.75% by weight of slaked lime fines of 0-3 mm and of 10.25% by weight of a mixture of carbon (Blaskohle Luxcarbon 97 DCE 0-2 mm) and glycerol (97.5 weight % of carbon and 2.5 weight % of glycerol). The total flow rate of the powder is 300 kg/h and the dwelling time is 3.5 s. The obtained mixture is very homogeneous. This means that the carbon content for different 10 g samples taken from the final mixture is always comprised between 9 and 11% (+/−10% relatively).

A rotary press Eurotab of the Titan type as described in example 1 is used. Starting with about thirty kilograms of the mixture, 12.8 g of this mixture are successively poured into each of the dies of the tooling with a substantially cylindrical shape having a section reducing downwards for the compact portion and a diameter of about 21 mm. Compression is performed under a pressure of 500 MPa, with a closing-in speed of the punches of 115 mm/s and a maintaining time of 105 ms.

Several kilograms of compacts each having a weight of 12.8 g and a mean median diameter of 21.4 mm are obtained. The upper diameter of the upper (top) part of the compacts has a mean value of 21.48 mm and the lower diameter of the lower part (bottom) of the compacts has a mean value of 21.32 mm, leading respectively to an upper surface of the upper part with a mean value of 362 mm² and to a lower surface of the lower part with a mean value of 357 mm². By consequence, the difference between the mean upper surface and the mean lower surface of said compacts reported to the mean median section of the compact is equal to 1.50% [(mean upper surface of the upper part-lower surface of the lower part)/median section of the compact].The height is 16.4 mm and the density is 2.25 g/cm³. These compacts have homogeneous quality and are free from macroscopic defects.

A Shatter Test is conducted starting with 0.5 kg of these compacts by successively performing 4 two-meter falls. The amount of fines of less than 10 mm generated at the end of these 4 falls is weighed. A Shatter Test Index of 5.0% is obtained.

### Example 6

A powder mixer Gericke GCM450 is used with a capacity of 10 dm³, equipped with standard blades with a radius of 7 cm, used in rotation at 350 revolutions per minute (i.e. 2.6 m/s). This mixer is used in a continuous mode in order to prepare a mixture consisting of 45% by weight of slaked lime fines of 0-3 mm, of 15% by weight of metal Al 0-200 μm, of 30 weight % of Al₂O₃ (0-3 mm) and of 10 weight % slaked lime. The total flow rate of the powder is 300 kg/h and the dwelling time is 3.5 s. The obtained mixture is very homogeneous. This means that the content in aluminum compound (metal Al or Al₂O₃) for different 10 g samples taken from the final mixture is always comprised between 13 and 17% and 28% and 32% (+/−10% relatively).

A rotary press Eurotab of the Titan type as described in example 1 is used. 12.8 g of the mixture are successively poured into each of the dies of the tooling with a substantially cylindrical shape having a section reducing downwards for the compact portion and a diameter of about 21 mm. Compression is performed under a pressure of 470 MPa, with a closing-in speed of the punches of 115 mm/s and a maintaining time of 105 ms.

Several kilograms of cylindrical compacts each having a weight of 12.8 g and a median diameter of 21.2 mm are obtained. The height is 16.4 mm and the density is 2.25 g/cm³. These compacts have homogeneous quality and are free from macroscopic defects.

These compacts develop a BET specific surface area of 4.8 m²/g and have a total mercury pore volume of 37%.

A Shatter Test is conducted starting with 0.5 kg of these compacts by successively performing 4 two-meter falls. The amount of fines of less than 10 mm generated at the end of these 4 falls is weighed. A Shatter Test Index of 3.0% is obtained.

It is obvious that the present invention is by no means limited to the embodiments described above and that many modifications may be provided thereto without departing from the scope of the appended claims.

1. A composition comprising at least one calcium-magnesium compound fitting the formula aCaCO₃.bMgCO₃.xCaO.yMgO.zCa(OH)₂.tMg(OH)₂.ul, wherein I is impurities; a, b, z, t and u each being mass fractions ≧0 and ≦50%, x and y each being mass fractions ≧0 and ≦100%, with x+y≧50% by weight, based on the total weight of said at least one calcium-magnesium compound, characterized in that
said at least one calcium-magnesium compound is in the form of particles, said composition has a cumulative calcium and magnesium content in the form of oxides, greater than or equal to 20% by weight based on the total weight of the composition,
said composition further comprises at least one second compound selected from the group consisting of B₂O₃, NaO, calcium aluminate, calcium silicate, calcium ferrite selected from the group consisting of Ca₂Fe₂O₅ and CaFe₂O₄, metal Al, metal Mg, metal Fe, metal Mn, metal Mo, metal Zn, metal Cu, elemental Si, CaF₂ CaC₂, alloys selected from the group consisting of CaSi, CaMg, CaFe, FeMn, FeSi, FeSiMn, FeMo; TiO₂, an oxide based on molybdenum, an oxide based on copper, an oxide based on zinc, a hydroxide based on molybdenum, a hydroxide based on copper, a hydroxide based on zinc and their mixture,
said composition is in the form of compacts, each compact being formed with compacted and shaped particles of calcium-magnesium compounds, said compacts having a Shatter Test Index of less than 20%.

2. The composition according to claim 1, wherein said second compound chosen in the group consisting of B₂O₃, NaO₃, calcium aluminate, calcium silicate, calcium ferrite such as Ca₂Fe₂O₅ or CaFe₂O₄, metal Al, metal Mg, metal Fe, metal Mn, metal Mo, metal Zn, metal Cu, elemental Si, CaF₂, C, CaC₂, alloys such as CaSi, CaMg, CaFe, FeMn, FeSi, FeSiMn, FeMo; TiO₂, an oxide based on molybdenum, an oxide based on copper, an oxide based on zinc, a hydroxide based on molybdenum, a hydroxide based on copper, a hydroxide based on zinc and their mixture is comprised into the composition at a content equal or greater to 1 weight based on the total weight of the composition.

3. The composition according to claim 1, wherein said second compound is selected from the group consisting of B₂O₃, NaO₃, metal Al, metal Mg, metal Fe, metal Mn, metal Mo, metal In, metal Cu, elemental Si, CaC₂, alloys selected from the group consisting of CaSi, CaMg, Cafe, Mn, FeSi, FeSiMn, FeMo; TiO₂, an oxide based on molybdenum, an oxide based on copper, an oxide based on zinc, a hydroxide based on molybdenum, a hydroxide based on copper, a hydroxide based on zinc and their mixture and is comprised into the composition at a content equal to or lower than 20 weight % based on the total weight of the composition.

4. The composition according to claim 1, wherein said second compound is chosen in the group consisting of CaF₂, calcium ferrites like for instance Ca₂Fe₂O₅ or CaFe₂O₄ and their mixture and is comprised into the composition at a content equal to or lower than 40 weight % based on the total weight of the composition.

5. The composition according to claim 1, wherein said second compound is chosen in the group consisting of calcium aluminate, calcium silicate, carbon and their mixture and is comprised into the composition at a content, equal to or lower than 60 weight % based on the total weight of the composition.

6. The composition according to claim 1, wherein said at least one calcium-magnesium compound has mass fractions such that x+y≧60% based on the total weight of said at least one calcium-magnesium compound.

7. The composition according to claim 1, wherein said compacts have a Shatter Test index of less than 15%.

8. The composition according to claim 1, wherein the cumulative calcium and magnesium content in the form of oxides is greater than or equal to 40% by weight based on the total weight of the composition.

9. The composition according to claim 1, further comprising at least one third compound selected from the group consisting of an organic additive selected from the group consisting of a binder, a lubricant and their mixture, an oxide selected from the group consisting of an oxide based on aluminum, an oxide based on silicon, an oxide based on iron, an oxide based on manganese, and their mixture, a hydroxide selected from the group consisting of a hydroxide based on aluminum, a hydroxide based on silicon, a hydroxide based on iron, a hydroxide based on manganese and their mixture, preferably at a content equal to or greater than 1 weight % and equal to or lower than 40 weight %, based on the total weight of the composition.

10. The composition according to claim 1, wherein said particles have a size of less than or equal to 7 mm, observable by optical microscopy or by scanning, electron microscopy and before compaction having a size of particles d₁₀₀ of less than or equal to 7 mm.

11. The composition according to claim 1, wherein said particles of said at least one calcium-magnesium compound before compaction have a d₉₀ of less than or equal to 3 mm.

12. The composition according to claim 1, said particles of said at least one calcium-magnesium compound before compaction have a d₅₀ of less than, or equal to 1 mm.

13. The composition according to claim 1, wherein said compacts are of a global regular and homogeneous shape which is typical of products from methods for shaping fines via a dry route, such shapes being selected form the group consisting of lozenges, tablets, compressed tablets, but with a small asymmetry between the lower (bottom) part and the upper (top) part of said compacts, and have a size comprised between 10 and 100 mm.

14. The composition according to claim 1, wherein said compacts have an average weight per compact of at least 1 g.

15. The composition according to claim 1, wherein said compacts have an average weight per compact of less than or equal to 200 g.

16. The composition according to claim 1, wherein said compacts have an apparent density comprised between 1.5 g/cm³ and 3 g/cm³.

17. The composition according to claim 1, wherein said compact includes a through-orifice.

18. The composition according to claim 1, wherein said compact is free of macrodefects, on the basis of simple visual inspection, of inspection under an optical microscope or further of inspection with a scanning electron microscope (SEM).

19. (canceled)

20. A method for making a composition in the form of a compact comprising the following steps:
a) providing particles of at least one calcium-magnesium compound fitting the formula aCaCO₃.bMgCO₃.xCaO.yMgO.zCa(OH)₂.tg(OH)₂.uI, wherein I represents impurities, a, b, z, t and u each being mass fractions ≧0 and ≦50%, x and y each being mass fractions ≧0 and ≦100%, with x÷y≧50% by weight based on the total weight of the calcium-magnesium compound,
b) adding at least one second compound to the particles of at least one calcium-magnesium compound, selected from the group consisting of B₂O₃, NaO₃, calcium aluminate, calcium silicate, calcium ferrite such as Ca₂Fe₂O₅ or Ca₂Fe₂O₄, metal Al, metal Mg, metal Fe, metal Mn, metal Mo, metal Zn, metal Cu, elemental Si, CaF₂C, CaC₂, alloys such as CaSi, CaMg, CaFe, FeMn, FeSi, FeSiMn, FeMo; TiO₂, an oxide based on molybdenum, an oxide based on copper, an oxide based on zinc, a hydroxide based on molybdenum, a hydroxide based on copper, a hydroxide based on zinc and their mixture, at a content equal or greater to 1 weight % based on the total weight of the composition,
c) mixing said particles and the second compound until an homogeneous composition is reached,
d) providing said homogeneous composition in a confinement space between two punches having a section comprised between 1 and 40 cm²,
e) compacting said homogeneous composition for forming a compact product with a three-dimensional shape, by applying a compaction pressure comprising 200 MPa and 800 MPa,
f) releasing the compaction pressure and
g) ejecting said compact product from said confinement space.

21. The method according to claim 20, wherein said second compound is selected from the group consisting of B₂O₃, NaO₃, metal Al, metal Mg, metal Fe, metal Mn, metal Mo, metal Zn, metal Cu, elemental Si, CaC₂, alloys such as CaSi, CaMg, CaFe, FeMn, FeSi, FeSiMn, FeMo; TiO₂, an oxide based on molybdenum, an oxide based on copper, an oxide based on zinc, a hydroxide based on molybdenum, a hydroxide based on copper, a hydroxide based on zinc and their mixture and is comprised into the composition at a content equal to or lower than 20 weight % based on the total weight of the composition.

22. The method according to claim 20, wherein said second compound is chosen in the group consisting of CaF₂, calcium ferrites selected from thegroup consisting of Ca₂Fe₂O₅ or CaFe₂O and their mixture and is comprised into the composition at a content equal to or lower than 40 weight %, based on the total weight of the composition.

23. The method according to claim 20, wherein said second compound is selected from the group consisting of calcium illuminate, calcium silicate, carbon and their mixture and is comprised into the composition at a content equal to or lower than 60 weight % based on the total weight of the composition.

24. The method according to claim 20, comprising a further step of adding, a third compound chosen in the group consisting of an organic additive selected from the group consisting of a binder, a lubricant and their mixture, an oxide selected from the group consisting of an oxide based on aluminum, an oxide based on silicon, an oxide based on iron, an oxide based on manganese, and their mixture, a hydroxide chosen in the group consisting of a hydroxide based on aluminum, a hydroxide based on silicon, a hydroxide based on iron, a hydroxide based on manganese and their mixture, said third compound having a hardness greater than or equal to 5 on the Mohs scale, and a size of particles d₁₀₀ of less than or equal to 200 μm before said step of providing said homogeneous composition in a confinement space d).

25. The method according to claim 20, wherein said space confined between said two punches is lubricated beforehand by means of a lubrication step during which a lubricant in the form of a powder, said powder being selected from the group consisting of calcium or magnesium stearate, is deposited at the surface of said space confined between said two punches, said lubricant in the form of a powder being compacted with the particles of the composition of particles and represents advantageously between 0.01 and 0.3% by weight based on the total weight of the compact product.

26. The method according to claim 20, wherein said collected compact product is then thermally treated between 700° C. and 1200° C. for a predetermined time period comprised between 1 and 90 minutes.

27. The method according to claim 20, further comprising a step for surface treatment of said collected compact product, optionally after thermal treatment if it is present, at a temperature greater than or equal to 50° C., and less than or equal to 700° C., for a time period comprising between 5 and 60 minutes under a flow of gas containing CO₂ and steam.

28. A method for making a composite material comprising several successive layers in order to form a multi-layer structure wherein at least one layer is formed with said compact product of the composition by the method according to claim 20 and further comprising an additional compaction step for said at least one layer of said compact product and fur another compact layer before said ejection step.

29. (canceled)
